(19) United States
(12) Patent Application Publication
(10) Pub. No.: US 2026/0280284 A1
(43) Pub. Date: Sep. 17, 2026

(54) COORDINATED CONTROL METHOD FOR MUTIPLE HIGH-VOLTAGE DIRECT CURRENT (HVDC) LINKS AFTER FAULT BASED ON EXTENDED EQUAL AREA CRITERION

(71) Applicant: HUNAN UNIVERSITY, Changsha (CN)

(72) Inventors: Lipeng ZHU, Changsha (CN); Weizhi HUANG, Changsha (CN); Chen YU, Changsha (CN); Shaocong GONG, Changsha (CN); Jie HOU, Changsha (CN); Hui FANG, Changsha (CN); Zhongyi WEN, Changsha (CN)

(73) Assignee: HUNAN UNIVERSITY, Changsha (CN)

(21) Appl. No.: 19/562,958

(22) Filed: Mar. 11, 2026

(30) Foreign Application Priority Data
Mar. 11, 2025 (CN) 202510285578.4

(51) Int. Cl. H02J 3/001; H02J 3/36; H02J 3/38; H02J 101/24

(52) U.S. Cl. CPC H02J 3/00125; H02J 3/36; H02J 3/381; H02J 2101/24

(57) ABSTRACT

A coordinated control method for multiple high-voltage direct current (HVDC) links after a fault based on an Extended Equal Area Criterion includes the following steps: S1: dividing a critical generator group G_{S} and a remaining generator group G_{A}; S2: calculating a support effect evaluation index of each DC converter station for all generators in the critical generator group G_{S} to determine an optimal DC converter station; S3: if a three-phase short-circuit fault occurs, reducing the power of the optimal DC converter station by f percentage points; if a DC fault occurs, increasing the power by f percentage points; S4: if the sign of the difference between the two equivalent angular velocities switches, re-determining the optimal DC converter station; S5: repeating S1-S4 until a duration of a DC power support reaches a short-term overload time limit tₛ of a converter station.

### CROSS REFERENCE TO THE RELATED APPLICATIONS

This application is based upon and claims priority to Chinese Patent Application No. 202510285578.4, filed on Mar. 11, 2025, the entire contents of which are incorporated herein by reference.

### TECHNICAL FIELD

The present invention relates to the technical field of power systems, and in particular, to a coordinated control method for multiple high-voltage direct current (HVDC) links after a fault based on an Extended Equal Area Criterion.

### BACKGROUND

With the increasing impact of the grid integration of ten-million-kilowatt scale renewable energy on system safety and stability, the DC sending-end system shows the characteristics of “double high” (a high proportion of renewable energy and a high proportion of power electronic equipment). This poses enormous challenges to the stability control of DC transmission systems in high-altitude clean energy bases under the present condition of weak alternating current (AC) support.

Renewable energy generating units such as photovoltaic and wind power units do not have the same rotor dynamic characteristics as traditional thermal power units, leading to a significant lack of active support capability of the sending-end system in comparison with traditional power systems and a limited damping effect on fault impacts. When a DC blocking fault or an AC system fault occurs in the system, a large amount of unbalanced power accumulates in the sending-end system. Meanwhile, large-scale power flow transfer within the system will trigger a continuous swing of the power angles of all generators in the sending-end system, thereby posing a severe threat to the transient power angle stability of the system. Existing studies are mainly carried out from the perspective of the receiving-end power grid, emphasizing that the range of DC power modulation must match the robustness of the receiving-end power grid to prevent inappropriate DC power increase from inducing successive commutation failures of multiple HVDC links. However, most of the multiple HVDC links transmission projects in China at this stage adopt hybrid DC transmission formed by the hybrid connection of conventional DC and voltage source converter-based high voltage direct current (VSC-HVDC). The receiving-end stations of hybrid DC are generally VSCs that are free from commutation failures. Some other studies have focused on the support effect of the DC power support on the system safety and stability after an AC fault in AC-DC hybrid power grids. Although such studies comprehensively consider the safety and stability of both the sending-end and receiving-end power grids, their research objects are mostly a single HVDC link, and the scenarios of DC faults are not fully taken into account.

Therefore, in a multi-link high-capacity hybrid HVDC transmission system, how to construct a coordinated control method for multiple HVDC links targeting the transient power angle stability problem of the sending-end system remains an urgent technical problem to be solved.

### SUMMARY

In view of the above, the present invention provides a coordinated control method for multiple HVDC links after a fault based on an Extended Equal Area Criterion, which is used to solve at least the problem of instability of transient power angle existing in multiple HVDC links transmission projects in the prior art.

To achieve the above objective, the present invention adopts the following technical solution:

A coordinated control method for multiple HVDC links after a fault based on an Extended Equal Area Criterion, including the following steps:
S1: acquiring monitored angular velocity data of all generators in a sending-end system after the fault, and dividing a critical generator group G_{S} and a remaining generator group G_{A} according to the monitored angular velocity data;
S2: calculating a support effect evaluation index of each DC converter station for all generators in the critical generator group G_{S} to determine a DC converter station with an optimal support effect as an optimal DC converter station;
S3: if a fault type is a three-phase short-circuit fault, reducing a power of the optimal DC converter station by f percentage points; and if the fault type is a DC fault, increasing the power of the optimal DC converter station by f percentage points;
S4: considering a dynamic process of the system and a variation in relative magnitudes of an equivalent angular velocity of the critical generator group G_{S} and an equivalent angular velocity of the remaining generator group G_{A} in the dynamic process, i.e., re-determining the optimal DC converter station if a sign of a difference between the two equivalent angular velocities switches, where if the equivalent angular velocity of the critical generator group G_{S} is greater than the equivalent angular velocity of the remaining generator group G_{A}, a DC power of a present optimal DC converter station is increased by f percentage points, and otherwise, the DC power of the present optimal DC converter station is reduced by f percentage points; and
S5: repeating the steps S1 to S4 until a total time of all the DC power increases and reductions reaches a short-time overload time limit tₛ of a converter station.

Preferably, the specific content of S1 includes:
monitoring angular velocities of all the generators in the sending-end system after the fault, and correspondingly obtaining power angle curves of the generators;
calculating an angular velocity ω_{COI} of a center of inertia of the entire sending-end system based on the angular velocities of the generators, and correspondingly obtaining a power angle curve of the center of inertia; and
if a power angle curve of any generator in the sending-end system deviates from the power angle curve of the center of inertia, determining that a present generator is severely disturbed, and classifying the present generator into the critical generator group G_{S}; otherwise, classifying the present generator into the remaining generator group G_{A}.

Preferably, a calculation method for the angular velocity ω_{COI} of the center of inertia is as follows:

$${ω}_{COI} = \frac{1}{{M}_{T}} {\sum }_{i = 1}^{n} {M}_{i} {ω}_{i}$$

where M_{T} is the sum of inertia time constants of all the generators in the sending-end system; Mᵢ and ωᵢ are an inertia time constant and an angular velocity of an i-th generator in the sending-end system, respectively; and n is a number of generators in the sending-end system.

Preferably, the support effect evaluation index in S2 is a modulation coefficient, and a calculation method of the modulation coefficient is as follows:

$${γ}_{a} = {\sum }_{j = 1}^{x} \frac{{K}_{ja}}{{M}_{j}}$$

$$\{ \begin{matrix}{K}_{ja} = {V}_{j} {V}_{a} {Y}_{j , a} cos ( {δ}_{j} - {δ}_{a} ) \\ Δ {P}_{j} = {P}_{mj} - {P}_{ej} = {K}_{ja} Δ {P}_{dc}\end{matrix}$$

where γₐ is a modulation coefficient of any DC converter station a in the sending-end system of the multiple HVDC links; x is a number of generators included in the critical generator group; Kⱼₐ is a synchronizing power coefficient of the converter station a for any generator j in the critical generator group; Mⱼ is an inertia time constant of a generator j in the sending-end system; Vⱼ and Vₐ are an internal electromotive force of the generator j and a voltage amplitude of a converter bus of the converter station a, respectively; δ-δ_{A} represents a phase difference between Vⱼ and Vₐ; Y_{j,a} is a mutual admittance between a bus of the generator j and the converter bus of the converter station a; ΔPⱼ is a reduction in an accelerating power of the generator after a DC emergency power support; Pₘⱼ and Pₑⱼ are a mechanical power and an electromagnetic power of the generator j, respectively; and ΔP_{dc} is a power value increased or reduced by the DC converter station.

Preferably, the specific content of S4 includes:
denoting the equivalent angular velocity of the critical generator group G_{S} and the equivalent angular velocity of the remaining generator group G_{A} as ω_{GS} and ω_{GA}, respectively;
considering the dynamic process of the system and the variation in the relative magnitudes of the angular velocity of the critical generator group G_{S} and the angular velocity of the remaining generator group G_{A} in the dynamic process, and adjusting the power of the present optimal DC converter station in a transient process within m seconds:
when ω_{GS}−ω_{GA}>0, an equivalent sending-end system is in forward acceleration and forward deceleration stages, and the DC power of the present optimal DC converter station is increased to decrease a forward swing acceleration area and increase a forward swing deceleration area; and
when ω_{GS}−ω_{GA}<0, the equivalent sending-end system is in reverse acceleration and reverse deceleration stages, and the DC power of the present optimal DC converter station is reduced to increase a reverse swing deceleration area and decrease a reverse swing acceleration area.

Preferably, a calculation method for the equivalent angular velocity ω_{GS} of the critical generator group G_{S} and the equivalent angular velocity ω_{GA} of the remaining generator group GA is as follows:

$$\{ \begin{matrix}{ω}_{GS} = \frac{1}{{M}_{GS}} {\sum }_{k = 1}^{x} {M}_{k} {ω}_{k} \\ {ω}_{GA} = \frac{1}{{M}_{GA}} {\sum }_{t = 1}^{y} {M}_{t} {ω}_{t}\end{matrix}$$

where M_{GS} and M_{GA} are the sum of inertia time constants of all the generators belonging to the critical generator group G_{S} and the sum of inertia time constants of all generators belonging to the remaining generator group G_{A}, respectively; Mₖ and ωₖ are an inertia time constant and an angular velocity of a k-th generator belonging to the critical generator group, respectively; Mₜ and ωₜ are an inertia time constant and an angular velocity of a t-th generator belonging to the remaining generator group, respectively; x and y are the number of generators included in the critical generator group and the number of generators included in the remaining generator group, respectively.

Preferably, the specific content of S5 includes:
repeating steps S1 to S4 until a duration of a DC power support reaches the short-time overload time limit tₛ of the converter station; and
if tₛ is reached, increasing a power of non-faulty DC converter stations to a long-term overload coefficient L_{c} of the DC converter station for all fault types until the power angle curves after the fault oscillate and attenuate to be stable.

It can be seen from the above technical solution that, compared with the prior art, the present invention discloses a coordinated control method for multiple HVDC links after a fault based on an Extended Equal Area Criterion, which has the following beneficial effects:

Firstly, the present invention proposes a method for identifying a severely disturbed generator group after a fault based on the generator group equivalence idea in the Extended Equal Area Criterion, which facilitates the localization of the severely disturbed generator group after the occurrence of a fault. Secondly, on the basis of this identification method, by utilizing the power adjustable characteristic of DC converter stations, through the coordinated modulation of the power of multiple HVDC links and the rational dispatching of the internal power in each region of the sending-end system, the unbalanced power caused by the fault is eliminated, the equivalent acceleration area of the system is reduced, and the equivalent deceleration area of the system is increased, thereby ultimately achieving the effect of maintaining the power angle stability of the sending-end system after the fault. The dispatching of DC power is correlated with the power angle stability of the entire sending-end system through the Extended Equal Area Criterion, which makes up for the gaps in the applicability to the sending-end system and the application to multiple HVDC links in the prior art.

### BRIEF DESCRIPTION OF THE DRAWINGS

To explain the technical solutions in the embodiments of the present invention or the prior art more clearly, the drawings used in the description of the embodiments or the prior art will be briefly introduced below. Obviously, the drawings in the following description are only some embodiments of the present invention, and those having ordinary skill in the art can obtain other drawings based on these drawings without exerting creative work.

FIG. 1 is a flow chart of a coordinated control method for multiple HVDC links after a fault based on an Extended Equal Area Criterion according to the present invention;
FIG. 2 is a diagram of an equivalent two-machine system according to an embodiment of the present invention;
FIGS. 3A-3B show power angle-active power curve diagrams of an equivalent single machine under two types of faults according to an embodiment of the present invention, where FIG. 3A indicates a DC blocking fault, and FIG. 3B indicates a permanent three-phase N-1 fault;
FIG. 4 is a diagram of a simulation example of a multiple HVDC links transmission system in Power System Dynamics-Block Power Analysis (PSD-BPA) according to an embodiment of the present invention; and
FIGS. 5A-5B show schematic diagrams of the power angle curves of each generator in the system before and after a DC power support according to an embodiment of the present invention, where FIG. 5A indicates the state before support, and FIG. 5B indicates the state after support.

### DETAILED DESCRIPTION OF THE EMBODIMENTS

The technical solutions in the embodiments of the present invention will be clearly and completely described below in conjunction with the drawings in the embodiments of the present invention. Obviously, the described embodiments are only a part of the embodiments of the present invention, rather than all the embodiments. All other embodiments obtained by those having ordinary skill in the art based on the embodiments of the present invention without exerting creative work shall fall within the scope of protection of the present invention.

The present invention provides a coordinated control method for multiple HVDC links after a fault based on an Extended Equal Area Criterion, which, as shown in FIG. 1, includes the following steps:
S1: acquire monitored angular velocity data of all generators in a sending-end system after the fault, and divide a critical generator group G_{S} and a remaining generator group GA according to the monitored angular velocity data;
S2: calculate a support effect evaluation index of each DC converter station for all generators in the critical generator group G_{S} to determine a DC converter station with an optimal support effect as an optimal DC converter station;
S3: if a fault type is a three-phase short-circuit fault, reduce a power of the optimal DC converter station by f percentage points; and if the fault type is a DC fault, increase the power of the optimal DC converter station by f percentage points;
S4: consider a dynamic process of the system and a variation in relative magnitudes of an equivalent angular velocity of the critical generator group G_{S} and an equivalent angular velocity of the remaining generator group G_{A} in the dynamic process, i.e., re-determine the optimal DC converter station if the sign of the difference between the two equivalent angular velocities switches, where if the equivalent angular velocity of the critical generator group G_{S} is greater than the equivalent angular velocity of the remaining generator group G_{A}, a DC power of a present optimal DC converter station is increased by f percentage points, and otherwise, the DC power of the present optimal DC converter station is reduced by f percentage points; and
S5: repeat steps S1 to S4 until a total time of all the DC power increases and reductions reaches a short-time overload time limit tₛ of a converter station.

It should be noted that:
in this embodiment, an electromechanical transient simulation software is adopted to record the angular velocities of all the generators in the sending-end system after the fault and calculate an angular velocity ωcol of the center of inertia of the entire sending-end system; and PSD-BPA is used as the time-domain simulation software in this embodiment.

In the present invention, the value obtained by increasing the DC power of the converter station by f percentage points is the DC power overload limit of the converter station, and the value of f is set to 30 in this embodiment.

The content of the Extended Equal Area Criterion described in the present invention is explained as follows:

### 1. Generator Group Equivalence Idea:

The diagram of the equivalent two-machine system is shown in FIG. 2. A large amount of unbalanced power accumulates in the sending-end system after a fault, and all generators can be divided into two equivalent generator groups: the critical generator group G_{S} of being severely disturbed and first swinging a power angle, and the remaining generator group G_{A} of being mildly disturbed. The rotor motion equations of the two equivalent machines are further simplified and equivalent to obtain an equivalent single-machine infinite bus system, as shown in the following formula.

$$\{ \begin{matrix}{M}_{GS} \frac{{dω}_{GS}}{dt} = {P}_{GS} - \frac{{U}_{GS} {U}_{GA}}{{X}_{SA}} sin {δ}_{SA} - {P}_{dc} \\ {M}_{GA} \frac{{dω}_{GA}}{dt} = {P}_{GA} \frac{{U}_{GS} {U}_{GA}}{{X}_{SA}} sin {δ}_{SA} \\ \frac{{dω}^{′}}{d t} = ( \frac{{P}_{GS}}{{M}_{GS}} - \frac{{P}_{GA}}{{M}_{GA}} ) - \frac{{P}_{dc}}{{M}_{GS}} - ( \frac{1}{{M}_{GS}} + \frac{1}{{M}_{GA}} ) \frac{{U}_{GS} {U}_{GA}}{{X}_{SA}} sin {δ}_{SA}\end{matrix}$$

where M_{GS} and M_{GA} are an inertia time constant of the critical generator group and an inertia time constant of the remaining generator group, respectively; P_{GS} and P_{GA} are an active power output by the critical generator group and an active power output by the remaining generator group, respectively; U_{GS} and U_{GA} are a generator bus voltage of the critical generator group and a generator bus voltage of the remaining generator group, respectively; P_{dc} is the DC power; X_{SA} is a line reactance between the two equivalent generator groups; ω′ is an angular velocity of an equivalent single machine; δ_{SA} is a power angle of the equivalent single machine; and the equivalent single machine has an equivalent mechanical power of and

$$( \frac{{P}_{GS}}{{M}_{GS}} - \frac{{P}_{GA}}{{M}_{GA}} ) - \frac{{P}_{dc}}{{M}_{GS}} ,$$

an equivalent electromagnetic power of

$$( \frac{1}{{M}_{GS}} + \frac{1}{{M}_{GA}} ) \frac{{U}_{GS} {U}_{GA}}{{X}_{SA}} sin {δ}_{SA} .$$

### 2. Extended Equal Area Criterion for the Equivalent Single Machine:

The power angle-active power curves of the equivalent single machine under two types of faults are shown in FIGS. 3A-3B. The power characteristic of the equivalent single machine remains unchanged during a DC blocking fault, and the DC power can be regarded as a part of the equivalent mechanical power. Therefore, the fault impact can be regarded as the change of the equivalent mechanical power of the system from the straight line P=Pₘ′ to P=Pₘ″. The acceleration area of the equivalent single machine is S_{b′c′d′}, and the deceleration area of the equivalent single machine is So′d′. Increasing the DC power helps to reduce the acceleration area and increase the deceleration area, thereby preventing the acceleration of the equivalent single machine. After a three-phase short-circuit fault occurs, the faulty line is generally permanently removed to eliminate the fault, which is thus referred to as a permanent three-phase N-1 fault. In this scenario, the change process of the power characteristic curve of the equivalent single machine (normal→fault→removal) is Curve 1→Curve 3→Curve 2, while the equivalent mechanical power remains unchanged. At this time, the acceleration area of the equivalent single machine is S_{abce} and the deceleration area is S_{def}. Therefore, increasing the DC power helps to reduce the acceleration area and increase the deceleration area, thereby preventing the acceleration of the equivalent single machine. The above analysis is only for the forward swing (the forward acceleration and deceleration process of the system), and reducing the DC power during the reverse swing (the reverse acceleration and deceleration process of the system) can achieve the same effect.

To further implement the above technical solution, the specific content of S1 includes:
monitoring angular velocities of all the generators in the sending-end system after the fault, and correspondingly obtaining power angle curves of the generators;
calculating an angular velocity ω_{COI} of the center of inertia of the entire sending-end system based on the angular velocities of the generators, and correspondingly obtaining a power angle curve of the center of inertia; and
if a power angle curve of any generator in the sending-end system deviates from the power angle curve of the center of inertia, determining that a present generator is severely disturbed, and classifying the present generator into the critical generator group G_{S}; otherwise, classifying the present generator into the remaining generator group G_{A}.

To further implement the above technical solution, the calculation method for the angular velocity ω_{COI} of the center of inertia is as follows:

$${ω}_{COI} = \frac{1}{{M}_{T}} {\sum }_{i = 1}^{n} {M}_{i} {ω}_{i}$$

where M_{T} is the sum of inertia time constants of all the generators in the sending-end system; Mᵢ and ωᵢ are an inertia time constant and an angular velocity of the i-th generator in the sending-end system, respectively; and n is the number of generators in the sending-end system.

To further implement the above technical solution, the support effect evaluation index in S2 is a modulation coefficient, and the calculation method of the modulation coefficient is as follows:

$${γ}_{a} = {\sum }_{j = 1}^{x} \frac{{K}_{ja}}{{M}_{j}}$$

$$\{ \begin{matrix}{K}_{ja} = {V}_{j} {V}_{a} {Y}_{j , a} cos ( {δ}_{j} - {δ}_{a} ) \\ Δ {P}_{j} = {P}_{mj} - {P}_{ej} = {K}_{ja} Δ {P}_{dc}\end{matrix}$$

where γₐ is a modulation coefficient of any DC converter station a in the sending-end system of the multiple HVDC links; x is the number of generators included in the critical generator group; Kⱼₐ is a synchronizing power coefficient of the converter station a for the arbitrary generator j in the critical generator group; Mⱼ is a inertia time constant of the generator j in the sending-end system; Vⱼ and Vₐ are an internal electromotive force of the generator j and a voltage amplitude of a converter bus of the converter station a, respectively; δ-δ_{A} represents the phase difference between Vⱼ and Vₐ; Y_{j,a} is a mutual admittance between a bus of the generator j and the converter bus of the converter station a; ΔPⱼ is a reduction in an accelerating power of the generator after a DC emergency power support; Pₘⱼ and Pₑⱼ are a mechanical power and an electromagnetic power of the generator j, respectively; and ΔP_{dc} is the power value increased or reduced by the DC converter station.

To further implement the above technical solution, the specific content of S4 includes:
denoting the equivalent angular velocity of the critical generator group G_{S} and the equivalent angular velocity of the remaining generator group G_{A} as ω_{GS} and ωGA, respectively;
considering the dynamic process of the system and the variation in the relative magnitudes of the equivalent angular velocity of the critical generator group G_{S} and the equivalent angular velocity of the remaining generator group G_{A} in the dynamic process, and adjusting the power of the present optimal DC converter station in a transient process within m seconds:
when ω_{GS}−ω_{GA}>0, an equivalent sending-end system is in forward acceleration and forward deceleration stages, and the DC power of the present optimal DC converter station is increased to decrease a forward swing acceleration area and increase a forward swing deceleration area; and
when ω_{GS}−ω_{GA}<0, the equivalent sending-end system is in reverse acceleration and reverse deceleration stages, and the DC power of the present optimal DC converter station is reduced to increase a reverse swing deceleration area and decrease a reverse swing acceleration area.

It should be noted that:
in this embodiment, the value of m is set to 3.

To further implement the above technical solution, a calculation method for the equivalent angular velocity ω_{GS} of the critical generator group G_{S} and the equivalent angular velocity ω_{GA} of the remaining generator group G_{A} is as follows:

$$\{ \begin{matrix}{ω}_{GS} = \frac{1}{{M}_{GS}} {\sum }_{k = 1}^{x} {M}_{k} {ω}_{k} \\ {ω}_{GA} = \frac{1}{{M}_{GA}} {\sum }_{t = 1}^{y} {M}_{t} {ω}_{t}\end{matrix}$$

where M_{GS} and M_{GA} are the sum of inertia time constants of all the generators belonging to the critical generator group G_{S} and the sum of inertia time constants of all generators belonging to the remaining generator group G_{A}, respectively; Mₖ and ωₖ are an inertia time constant and an angular velocity of the k-th generator belonging to the critical generator group, respectively; Mₜ and ωₜ are an inertia time constant and an angular velocity of the t-th generator belonging to the remaining generator group, respectively; x and y are the number of generators included in the critical generator group and the number of generators included in the remaining generator group, respectively.

To further implement the above technical solution, the specific content of S5 includes:
repeating steps S1 to S4 until a duration of a DC power support reaches the short-time overload time limit tₛ of the converter station; and
if tₛ is reached, increasing a power of non-faulty DC converter stations to a long-term overload coefficient L_{c} of the DC converter station for all fault types until the power angle curves after the fault oscillate and attenuate to be stable, i.e., the oscillation attenuation approaches 0.

It should be noted that:
in this embodiment, L_{c} refers to the long-term overload coefficient of the DC converter station, which is generally 1.05 times the rated power of the converter station.

To verify the reliability of the method proposed in the present invention, a verification scenario for an emergency power support of multiple HVDC links is constructed subsequently by using a simulation example of an actual power grid in PSD-BPA, with the simulation time set to 14 s. A partial topological structure diagram of this example is shown in FIG. 4, where the single-pole rated transmission power of each of the converter stations C1, C2 and C3 is 2000 MW.

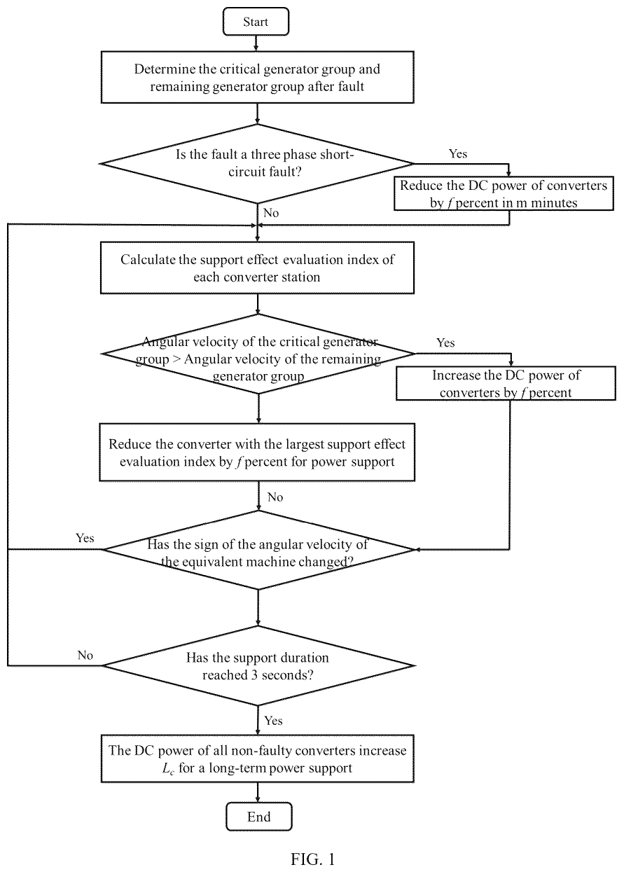

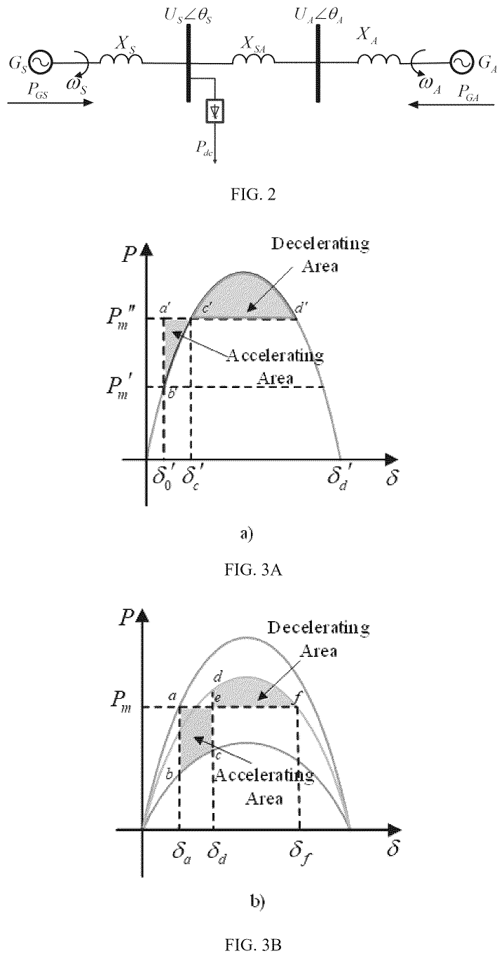

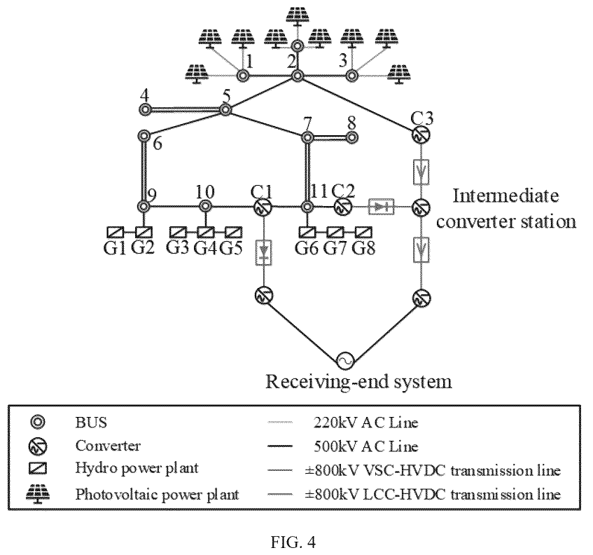

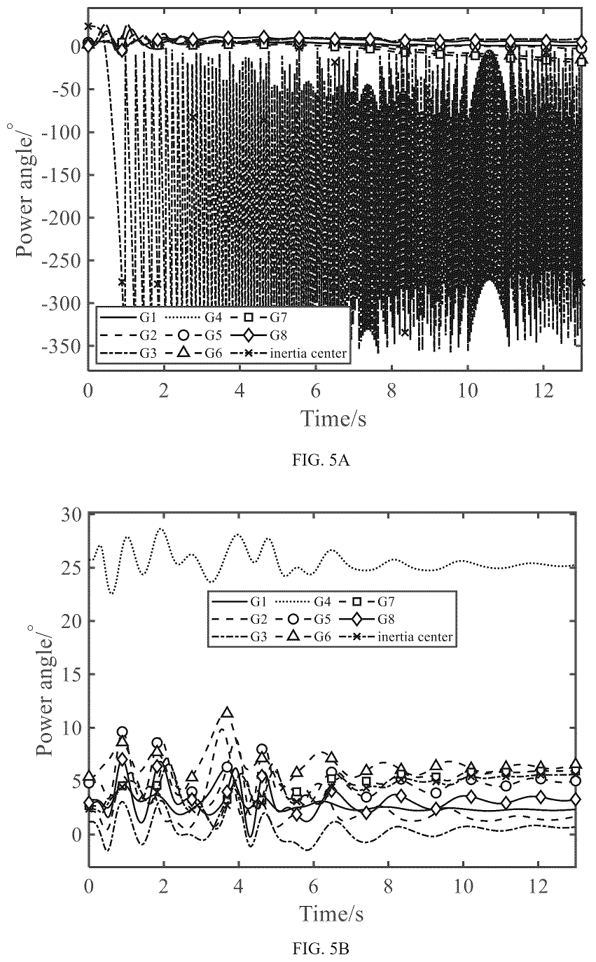

The fault scenario tested is selected as follows: a bipolar blocking fault occurs at the converter station C3 at 0.1 s after the start of the simulation. Under this fault scenario, the hydro-generator units in the sending-end system exhibit power angle oscillation without losing stability. After the fault occurs, the power angle curves of the 8 hydro-generator units G1-G8 in the sending-end system and the virtual center of inertia are shown in FIG. 5A. Since the power angle curves of G2, G3, GA and G8 deviate the most from the power angle curve of the center of inertia, these units are determined to form the critical generator group, and the remaining generators form the remaining generator group.

The modulation coefficients of the 2 non-faulty DC converter stations relative to all generators in the critical generator group are calculated separately at the fault occurrence moment (0.1 s) and the moments where the relative angular velocity between the critical generator group and the remaining generator group changes (0.51 s, 1.89 s, 2.76 s), as shown in Table 1.

TABLE 1
Modulation Coefficients of DC Converter Stations Relative
to Generators in the Critical Generator Group

| | 0.1 s | 0.51 s | 1.89 s | 2.76 s |
|---|---|---|---|---|
| modulation coefficient of | 33.776 | 58.556 | 71.699 | 19.098 |
| converter station C1 | | | | |
| modulation coefficient of | 36.300 | 40.081 | 81.594 | 45.487 |
| converter station C2 | | | | |

Therefore, the DC emergency power strategy for this scenario is formulated as follows: at 0.1 s after the start of the simulation, the power of the converter station C1 remains unchanged and the power of the converter station C2 is increased to 2600 MW; at 0.51 s, the power of the converter station C1 is increased to 2600 MW and the power of the converter station C2 is reduced to 2000 MW; at 1.89 s, the power of the converter station C1 is reduced to 2000 MW and the power of the converter station C2 is increased to 2600 MW; at 2.76 s, the power of the converter station C1 and the power of the converter station C2 remain unchanged; after 3 s, the power of the converter station C1 and the power of the converter station C2 are maintained at 2100 MW until the end of the simulation.

After the emergency power support measure proposed in the present invention is adopted, the power angle amplitudes of all generators in the system are significantly decreased and show a trend of oscillatory attenuation, as shown in FIG. 5B. This verifies the effectiveness of the present invention. The above embodiments are only used to illustrate the technical solutions of the present application and not to limit them; although the present application has been described in detail with reference to the aforementioned embodiments, those having ordinary skill in the art should understand that modifications may still be made to the technical solutions recorded in the aforementioned embodiments, or equivalent substitutions may be made to some of their technical features; and such modifications or substitutions do not cause the essence of the corresponding technical solutions to depart from the spirit and scope of the technical solutions of various embodiments of the present application, and all shall be included within the scope of protection of the present application.

What is claimed is:

1. A coordinated control method for multiple high-voltage direct current (HVDC) links after a fault based on an Extended Equal Area Criterion, comprising the following steps:
S1: acquiring monitored angular velocity data of all generators in a sending-end system after the fault, and dividing a critical generator group G_{S} and a remaining generator group G_{A} according to the monitored angular velocity data;
S2: calculating a support effect evaluation index of each DC converter station for all generators in the critical generator group G_{S} to determine a DC converter station with an optimal support effect as an optimal DC converter station;
S3: if a fault type is a three-phase short-circuit fault, reducing a power of the optimal DC converter station by f percentage points; and if the fault type is a DC fault, increasing the power of the optimal DC converter station by f percentage points;
S4: considering a dynamic process of the system and a variation in relative magnitudes of an equivalent angular velocity of the critical generator group G_{S} and an equivalent angular velocity of the remaining generator group G_{A} in the dynamic process, i.e., re-determining the optimal DC converter station if a sign of a difference between the two equivalent angular velocities switches, wherein if the equivalent angular velocity of the critical generator group G_{S} is greater than the equivalent angular velocity of the remaining generator group G_{A}, a DC power of a present optimal DC converter station is increased by f percentage points, and otherwise, the DC power of the present optimal DC converter station is reduced by f percentage points; and
S5: repeating the steps S1 to S4 until a total time of all the DC power increases and reductions reaches a short-time overload time limit tₛ of a converter station.

2. The coordinated control method for the multiple HVDC links after the fault based on the Extended Equal Area Criterion according to claim 1, wherein a specific content of S1 comprises:
monitoring angular velocities of all the generators in the sending-end system after the fault, and correspondingly obtaining power angle curves of the generators;
calculating an angular velocity ω_{COI} of a center of inertia of the entire sending-end system based on the angular velocities of the generators, and correspondingly obtaining a power angle curve of the center of inertia; and
if a power angle curve of any generator in the sending-end system deviates from the power angle curve of the center of inertia, determining that a present generator is severely disturbed, and classifying the present generator into the critical generator group G_{S}; otherwise, classifying the present generator into the remaining generator group G_{A}.

3. The coordinated control method for the multiple HVDC links after the fault based on the Extended Equal Area Criterion according to claim 2, wherein a calculation method for the angular velocity ω_{COI} of the center of inertia is as follows:
$${ω}_{COI} = \frac{1}{{M}_{T}} {\sum }_{i = 1}^{n} {M}_{i} {ω}_{i}$$
wherein M_{T} is a sum of inertia time constants of all the generators in the sending-end system; Mᵢ and ωᵢ are an inertia time constant and an angular velocity of an i-th generator in the sending-end system, respectively; and n is a number of generators in the sending-end system.

4. The coordinated control method for the multiple HVDC links after the fault based on the Extended Equal Area Criterion according to claim 1, wherein the support effect evaluation index in S2 is a modulation coefficient, and a calculation method of the modulation coefficient is as follows:
$${γ}_{a} = {\sum }_{j = 1}^{x} \frac{{K}_{ja}}{{M}_{j}}$$
$$\{ \begin{matrix}{K}_{ja} = {V}_{j} {V}_{a} {Y}_{j , a} cos ( {δ}_{j} - {δ}_{a} ) \\ Δ {P}_{j} = {P}_{mj} - {P}_{ej} = {K}_{ja} Δ {P}_{dc}\end{matrix}$$
wherein γₐ is a modulation coefficient of any DC converter station a in the sending-end system of the multiple HVDC links; x is a number of generators comprised in the critical generator group; Kⱼₐ is a synchronizing power coefficient of the converter station a for any generator j in the critical generator group; Mᵢ is an inertia time constant of a generator j in the sending-end system;
Vⱼ and Vₐ are an internal electromotive force of the generator j and a voltage amplitude of a converter bus of the converter station a, respectively; δ-δ_{A} represents a phase difference between Vⱼ and Vₐ; Y_{j,a} is a mutual admittance between a bus of the generator j and the converter bus of the converter station a; ΔPⱼ is a reduction in an accelerating power of the generator after a DC emergency power support; Pₘⱼ and Pₑⱼ are a mechanical power and an electromagnetic power of the generator j, respectively; and ΔP_{dc} is a power value increased or reduced by the DC converter station.

5. The coordinated control method for the multiple HVDC links after the fault based on the Extended Equal Area Criterion according to claim 1, wherein a specific content of S4 comprises:
denoting the equivalent angular velocity of the critical generator group G_{S} and the equivalent angular velocity of the remaining generator group G_{A} as ω_{GS} and ωGA, respectively;
considering the dynamic process of the system and the variation in the relative magnitudes of the equivalent angular velocity of the critical generator group G_{S} and the equivalent angular velocity of the remaining generator group G_{A} in the dynamic process, and adjusting the power of the present optimal DC converter station in a transient process within m seconds:
when ω_{GS}-ω_{GA}>0, an equivalent sending-end system is in forward acceleration and forward deceleration stages, and the DC power of the present optimal DC converter station is increased to decrease a forward swing acceleration area and increase a forward swing deceleration area; and
when ω_{GS}−ω_{GA}<0, the equivalent sending-end system is in reverse acceleration and reverse deceleration stages, and the DC power of the present optimal DC converter station is reduced to increase a reverse swing deceleration area and decrease a reverse swing acceleration area.

6. The coordinated control method for the multiple HVDC links after the fault based on the Extended Equal Area Criterion according to claim 5, wherein a calculation method for the equivalent angular velocity ω_{GS} of the critical generator group G_{S} and the equivalent angular velocity ω_{GA} of the remaining generator group G_{A} is as follows:
$$\{ \begin{matrix}{ω}_{GS} = \frac{1}{{M}_{GS}} {\sum }_{k = 1}^{x} {M}_{k} {ω}_{k} \\ {ω}_{GA} = \frac{1}{{M}_{GA}} {\sum }_{t = 1}^{y} {M}_{t} {ω}_{t}\end{matrix}$$
wherein M_{GS} and M_{GA} are a sum of inertia time constants of all the generators belonging to the critical generator group G_{S} and a sum of inertia time constants of all generators belonging to the remaining generator group G_{A}, respectively; Mₖ and ωₖ are an inertia time constant and an angular velocity of a k-th generator belonging to the critical generator group, respectively; Mₜ and ωₜ are an inertia time constant and an angular velocity of a t-th generator belonging to the remaining generator group, respectively; x and y are a number of generators comprised in the critical generator group and a number of generators comprised in the remaining generator group, respectively.

7. The coordinated control method for the multiple HVDC links after the fault based on the Extended Equal Area Criterion according to claim 1, wherein a specific content of S5 comprises:
repeating steps S1 to S4 until a duration of a DC power support reaches the short-time overload time limit tₛ of the converter station; and
if tₛ is reached, increasing a power of non-faulty DC converter stations to a long-term overload coefficient L_{c} of the DC converter station for all fault types until the power angle curves after the fault oscillate and attenuate to be stable.
